(19) United States
(12) Patent Application Publication
(10) Pub. No.: US 2022/0147430 A1
(43) Pub. Date: May 12, 2022

(54) WORKLOAD PERFORMANCE PREDICTION

(71) Applicant: Hewlett-Packard Development Company, L.P., Spring, TX (US)

(72) Inventors: Carlos Haas Costa, Palo Alto, CA (US); Christian Makaya, Palo Alto, CA (US); Madhu Sudan Athreya, Palo Alto, CA (US); Raphael Gay, Fort Collins, CO (US); Pedro Henrique Garcez Monteiro, Porto Alegre (BR)

(73) Assignee: Hewlett-Packard Development Company, L.P., Spring, TX (US)

(21) Appl. No.: 17/415,766

(22) PCT Filed: Jul. 25, 2019
(86) PCT No.: PCT/US2019/043458

§ 371 Date: Jun. 18, 2021

(51) Int. Cl. G06F 11/34; G06N 20/00

(52) U.S. Cl. CPC G06F 11/3414; G06N 20/00

(57) ABSTRACT

For each of a number of workloads, time intervals within execution performance information that was collected during execution of the workload on a first hardware platform are correlated with corresponding time intervals within execution performance information that was collected during execution of the workload on a second hardware platform. For a workload, the time intervals within the execution performance information on the second hardware platform are correlated to the time intervals within the execution performance information the first hardware platform during which the same parts of the workload were executed. A machine learning model that outputs predicted performance on the second hardware platform relative to known performance on the first hardware platform is trained. The model is trained from the correlated time intervals within the execution performance information for each workload on the hardware platforms.

### BACKGROUND

Computing devices include server computing devices; laptop, desktop, and notebook computers; and other computing devices like tablet computing devices and handheld computing devices such as smartphones. Computing devices are used to perform a variety of different processing tasks to achieve desired functionality. A workload may be generally defined as the processing task or tasks, including which application programs perform such tasks, that a computing device executes on the same or different data over a period of time to realized desired functionality. Among other factors, the constituent hardware components of a computing device, including the number or amount, type, and specifications of each hardware component, can affect how quickly the computing device executes a given workload.

### BRIEF DESCRIPTION OF THE DRAWINGS

FIG. 1 is a flowchart of an example method for training a machine learning model that predicts performance of execution of a workload on a second hardware platform relative to known performance of execution of the workload on a first hardware platform.

FIG. 2 is diagram of example execution performance information collected on a first hardware platform while the first platform is executing a workload and example aggregation of the collected execution performance information.

FIG. 3 is a diagram of example correlation of time intervals within execution performance information that was collected during execution of a workload on a first hardware platform with corresponding time intervals within execution performance information that was collected during execution of the workload on a second hardware platform.

FIG. 4 is a diagram illustratively depicting an example of input on which basis a machine learning model is trained to predict performance of workload execution on a second hardware platform relative to known performance of workload execution on a first hardware platform, as in FIG. 1.

FIG. 5 is a flowchart of an example method for using a machine learning model trained as in FIGS. 1 and 4 to predict performance of execution of a workload on a second hardware platform relative to known performance of execution of the workload on a first hardware platform.

FIG. 6 is a diagram illustratively depicting an example of input on which basis a machine learning model is used to predict performance of workload execution on a second hardware platform relative to known performance of workload execution on a first hardware platform, as in FIG. 5.

FIG. 7 is a diagram illustratively depicting an example of input on which basis a machine learning model is trained and then used to predict performance of workload execution on a target hardware platform relative to known performance of workload execution on a source hardware platform, regardless of whether the model is trained on the source or hardware platform, consistent with but in extension of FIGS. 1, 4, 5, and 6.

FIG. 8 is a flowchart of an example method.

FIG. 9 is a diagram of an example computing device.

FIG. 10 is a diagram of an example non-transitory computer-readable data storage medium.

### DETAILED DESCRIPTION

As noted in the background, the number or amount, type, and specifications of each constituent hardware component of a computing device can impact how quickly the computing device can execute a workload. Examples of such hardware components include processors, memory, network hardware, and graphical processing units (GPUs), among other types of hardware components. The performance of different workloads can be differently affected by different hardware components. For example, the number, type, and specifications of the processors of a computing device can influence the performance of processing-intensive workloads more than the performance of network-intensive workloads, which may instead be more influenced by the number, type, and specifications of the network hardware of the device.

In general, though, the overall constituent hardware component makeup of a computing device affects how quickly the device can execute on a workload. The specific contribution of any given hardware component of the computing device on workload performance is difficult to assess in isolation. For example, a computing device may have a processor with twice the number of processing cores as the processor of another computing device, or may have twice the number of processors as the processor another computing device. However, the performance benefit in executing a specific workload on the former computing device instead of on the latter computing device may still be minor, even if the workload is processing intensive. This may be due to how the processing tasks making up the workload leverage a computing device's processors in operating on data, due to other hardware components acting as bottlenecks on workload performance, and so on.

Techniques described herein provide for a machine learning model to predict workload performance on a target hardware platform relative to known workload performance on a source hardware platform. Execution performance information for a workload is collected during execution of the workload on the source hardware platform and input into the model. The machine learning model in turn outputs predicted performance of the workload on the target hardware platform relative to the source hardware platform. As an example, for a given time interval in which the source platform executed a particular part of the workload, the model may output a ratio of the predicted execution time of the same part of the workload on the second hardware platform to the length of this time interval.

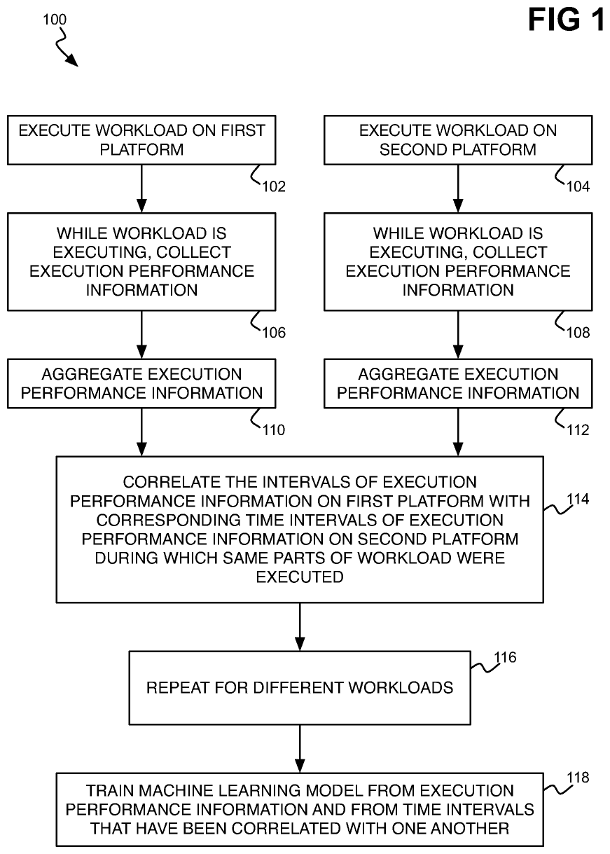

FIG. 1 shows an example method 100 for training a machine learning model to predict performance of a workload on a second hardware platform relative to known performance of the workload on a first hardware platform. The method 100 can be implemented as a non-transitory computer-readable data storage medium storing program code executable by a computing device. The machine learning model is trained on the first and second hardware platforms, and then can be subsequently used to predict workload performance on the second hardware platform relative to known workload performance on the first hardware platform.

The method 100 includes executing a training workload on each of the first hardware platform (102) and the second hardware platform (104), which may be considered training platforms. A hardware platform can be a particular computing device, or a computing device that with particularly specified constituent hardware components. The training workload may include one or more processing tasks that specified application programs run on provided data in a provided order. The same training workload is executed on each hardware platform.

The method 100 includes, while the workload is executing on the first hardware platform, collecting execution performance information of the workload on the first hardware platform (106), and similarly, while the workload is executing on the second hardware platform, collecting execution performance information of the workload on the second hardware platform (108). For example, the computing device performing the method 100 may transmit to each hardware platform an agent computer program that collects the execution performance information from the time that workload execution has started to the time that workload execution has finished. The agent computer program on each hardware platform may then transmit the execution performance information that it collected back to the computing device in question.

The execution performance information that is collected on a hardware platform can include values of hardware and software statistics, metrics, counters and, traces over time as the hardware platform executes the training workload. Such execution performance information can include processor-related information, GPU-related information, memory-related information, and information related to other hardware and software components of the hardware platform. The information can be provided in the form of collective metrics over time, which can be referred to as execution traces. Such metrics can include statistics such as percentage utilization, as well as event counter values such as the number of input/output (I/O) calls.

Specific examples of processor-related execution performance information can include total processor usage; individual processing core usage; individual core frequency; individual core pipeline stalls; processor accesses of memory; cache usage, number of cache misses, and number of cache hits in different cache levels; and so on. Specific examples of GPU-related execution performance information can include total GPU usage; individual GPU core usage; GPU interconnect usage; and so on. Specific examples of memory-related execution performance information can include total memory usage; individual memory module usage; number of memory reads; number of memory writes; and so on. Other types of execution performance information can include the number of I/O calls; hardware accelerator usage; the number of software stack calls; the number of operating system calls; the number of executing processes; the number of threads per process; network usage information; and so on.

The execution performance information that is collected does not, however, include the workload itself. That is, the collected execution performance information does not include the specific application programs, such as any code or any identifying information thereof, that are run as processing tasks as part of the workload. The collected execution performance information does not include the (user) data on which such application programs are operative during workload execution, or any identifying information thereof. The collected execution performance information does not include the order of operations that the processing tasks are performed on the data during workload execution. The execution performance information, in other words, is not specified as to what application programs a workload runs, the order in which they are run, or the data on which they are operative. Rather, the execution performance information is specified as to observable and measurable information of the hardware and software components of the hardware platform itself while the platform is executing the workload, such as the aforementioned execution traces (i.e., collected metrics over time).

The method 100 can include aggregating, or combining, the execution performance information collected on the first hardware platform (110), as well as the execution performance information collected on the second hardware platform (112). Such aggregation or combination can include preprocessing the collected execution performance information so that execution performance information pertaining to the same hardware component is aggregated, which can improve the relevancy of the collected information for predictive purposes. As an example, the computing device performing the method 100 may aggregate fifteen different network hardware-related execution traces that have been collected into just one network hardware-related execution trace, which reduces the amount of execution performance information on which basis machine learning model training occurs.

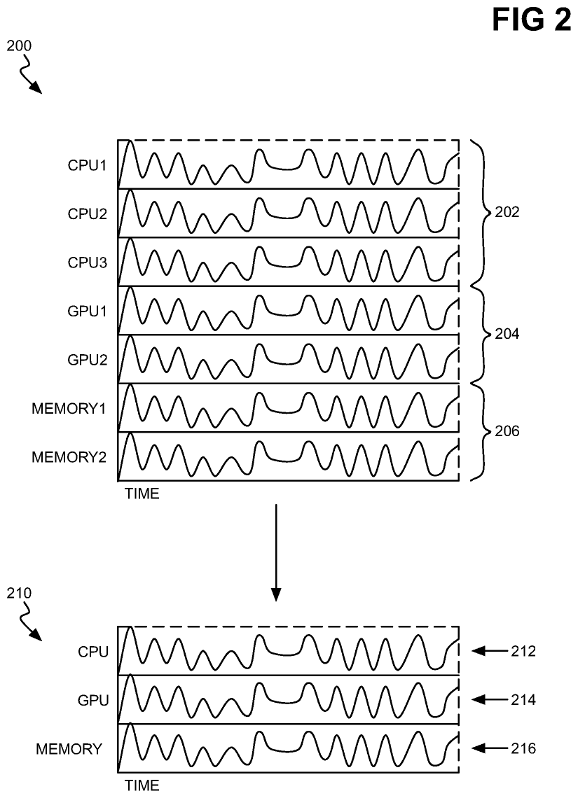

FIG. 2 illustratively shows example execution performance information 200 collected in part 106 or 108 on a hardware platform during execution of a work on the platform in part 102 or 104, as well as aggregation of such execution performance information 200 as the example aggregated execution performance information 210 in part 114 as to this platform. In the example of FIG. 2, the execution performance information 200 includes three processor (e.g., CPU)-related execution traces 202 (labeled CPU1, CPU2, and CPU3), two GPU-related execution traces 204 (labeled GPU1 and CPU2), and two memory-related execution traces 206 (labeled MEMORY1 and MEMORY2). Each of the execution traces 202, 204, and 206 is a measure of a metric over time, where the traces 202 are different CPU-related execution traces, the traces 204 are different GPU-related execution traces, and the traces 206 are different memory-related execution traces. It is noted that in FIG. 2 as well as in other figures in which execution traces are depicted, the execution traces are depicted as identical for illustrative convenience, when in actuality they will in all likelihood differ from one another.

In the example of FIG. 2, each of the execution traces 202, 204, and 206 is depicted as a continuous function to represent that the execution traces 202, 204, and 206 can each include values of a corresponding metric collected at each point in time. For example, the metrics may be collected every t milliseconds. In another implementation, however, each of the execution traces 202, 204, and 206 may include averages of the values of a metric collected over consecutive time periods T, where T is equal to N×t and N is greater than one (i.e., where each time period T spans multiple samples of the metric). Such an implementation reduces the amount of data on which basis the machine learning model is subsequently trained.

In the example of FIG. 2, the execution performance information 200 has been aggregated (i.e., combined) into aggregated execution performance information 210. Specifically, the processor-related execution traces 202 have been aggregated, or combined, into one aggregated processor-related execution trace 212, the GPU-related execution traces 204 have been aggregated, or combined, into one aggregated GPU-related execution trace 214, and the memory-related execution traces 206 have been aggregated, or combined, into one aggregated memory-related execution trace 216. Aggregation or combination of the execution traces that are related to the same hardware component can include normalizing the execution traces to a same scale, which may be unitless, and then averaging the normalized execution traces to realize the aggregated execution trace in question.

Referring back to FIG. 1, the method 100 includes correlating the time intervals over which the execution performance information has been collected on the first hardware platform with corresponding time intervals over which the execution performance information has been collected on the second platform in which the same parts of the training workload were executed (114). For example, in the time interval from time t1 to t2, the first hardware platform may have executed a particular part of the training workload. It is unlikely that the second hardware platform executed the same part of the training workload in the same time interval, because the second platform may be slower or faster in executing any given workload part.

The second hardware platform, for instance, may have executed the same part of the workload in the time interval from time t3 to t4. Depending on how quickly the second hardware platform executed prior parts of the workload as compared to the first hardware platform, time t3 may occur before or after time t1 (or time t2). Similarly, time t4 may occur before or after time t2 (or time t1). The duration or length of the time interval from t3 to t4 (i.e., t4-t3) may likewise be shorter or longer than the duration or length of the time interval from t1 to t2 (i.e., t2-t1).

However, the order in which the workload is executed on each hardware platform is the same. Therefore, the time interval in which a first part of the workload is executed on the first hardware platform occurs before the time interval in which a subsequent, second part of the workload is executed on the first platform. Likewise, the time interval in which the first part of the workload is executed on the first hardware platform occurs before the time interval in which the second part of the workload is executed on the second platform.

As noted above, the execution performance information does not include the workload itself. Therefore, the specific workload part to which any time interval of the execution performance information corresponds is not used when identifying time intervals in the workload performance information on each hardware platform and correlating time intervals between platforms. For instance, start and end points of time intervals within the execution performance information on a hardware platform may be identified based on changes in the execution traces. As an example, a change in each of more than a threshold number of execution traces of a hardware platform by more than a threshold percentage by more than a threshold percentage or amount may be identified as start and end points of time intervals, and then correlated to identified time interval start and end points within the execution traces on the other hardware platform.

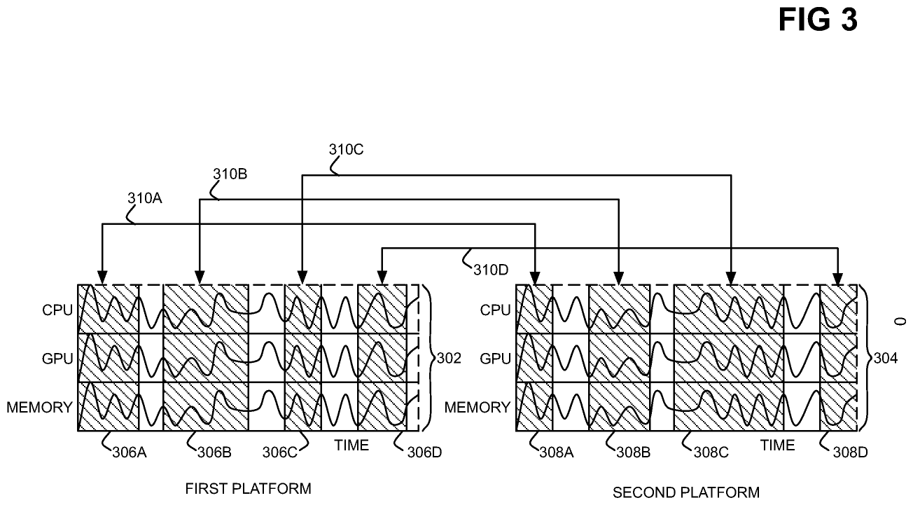

FIG. 3 illustratively shows example time interval correlation between the execution performance information 302 on the first hardware platform and the execution performance information 304 on the second hardware platform. The execution performance information 302 and 304 may each be aggregated execution performance information. Time intervals 306A, 306B, 306C, and 306D within the first platform's execution performance information 302 have been correlated with respective time intervals 308A, 308B, 308C, and 308D within the second platform's execution performance information 304, as the correlations 310A, 310B, 310C, and 310D, respectively.

For example, the correlation 310A between the time interval 306A of the execution performance information 302 and the time interval 308A of the execution performance information 304 identifies that the first hardware platform executed the same part of the training workload during the time interval 306A as the second hardware platform executed during the time interval 308A. The correlated time intervals 306A and 308A can differ in length and in interval beginning and ending times. The same is true of the correlations 310B, 310C, and 310D between the time intervals 306B and 308B, 306C and 308C, and 306D and 308D, respectively.

Referring back to FIG. 1, the method 100 includes repeating the process of parts 102-114 for each of a number of different training workloads on the same two hardware platforms (116). Therefore, for each training workload, the method 100 includes collecting execution performance information while executing the workload on each of the first and second hardware platforms, aggregating the execution performance information on each platform if desired, and then correlating time intervals between the two platforms. The result is training data, on which basis a machine learning model can then be trained.

Specifically, the machine learning model is trained from the execution performance information that has been collected on the first hardware platform in part 102 and the execution performance information that has been collected on the second hardware platform in part 104, and from the time intervals correlated between the two platforms in part 114 (118). While the time intervals may be correlated in part 114 on the basis of the collected execution performance information as aggregated in parts 110 and 112, the machine learning model may be trained based on the execution performance as collected in parts 102 and 104 and not as may have been further aggregated in parts 110 and 112. That is, if the execution performance information is aggregated in parts 110 and 112, such aggregation is employed for time interval correlation in part 114, and the aggregated execution performance information may not otherwise be used in part 118 for training the machine learning model.

The machine learning model may be one of a number of different types of such models. Examples of machine learning model that can be trained to predict workload performance on the second hardware platform relative to known workload performance on the first hardware platform including support vector regression (SVR) models, random forest models, linear regression models, as well as other type of regression-oriented models. Other types of machine learning models that can be trained include deep learning models such as neural network models and long short-term memory (LSTM) models, which may be combined with deep convolutional networks for regression purposes.

In the implementation of FIG. 1, the machine learning model is specific and particular to predicting workload performance on the second hardware platform relative to known workload performance on the first hardware platform. That is, the model is unable to be used to predict performance on a target hardware platform other than the second hardware platform, and is not able to be used to predict such performance in relation to known performance on a source hardware platform other than the first hardware platform. This is because the machine learning model is not trained using any information of the constituent hardware components of either the first or second hardware platform, and therefore cannot be generalized to make performance predictions with respect to any target platform other than the second platform, nor in relation to any source hardware other than the first platform. In such an implementation, the machine learning model is also directional, and cannot predict relative performance on the first platform from known performance on the second platform, although another model can be trained from the same execution performance information collected in parts 106 and 108.

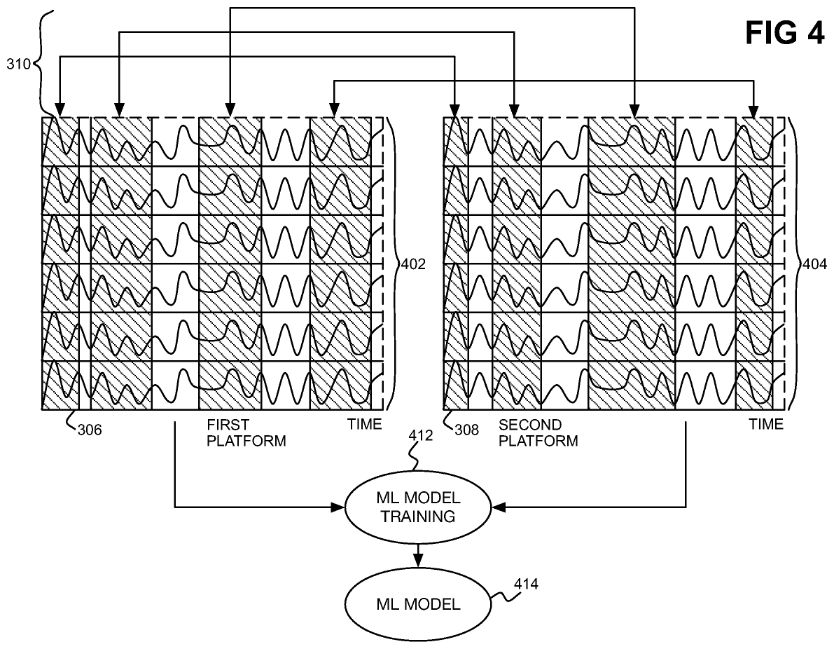

FIG. 4 illustratively shows example machine learning model training in part 118 of FIG. 1. Machine learning model training 412 occurs on the basis of execution performance information 402 collected in part 106 during workload execution on the first hardware platform in part 102, and execution performance information 404 collected in part 108 during workload execution on the second hardware platform in part 104. The machine learning model training 412 occurs further on the basis of the timing interval correlations 310 between the execution performance information 402 on the first hardware platform and the execution performance information 404 on the second hardware platform. The execution performance information 402 and 404 and the correlations 310 are depicted in FIG. 4 as to a single training workload, but in actuality machine learning model training 412 occurs using such execution performance information 402 and 404 and correlations 310 for each of a number of training workloads. The output of the machine learning model training 412 is a trained machine learning model 414 that can predict performance on the second hardware platform relative to known performance on the first hardware platform.

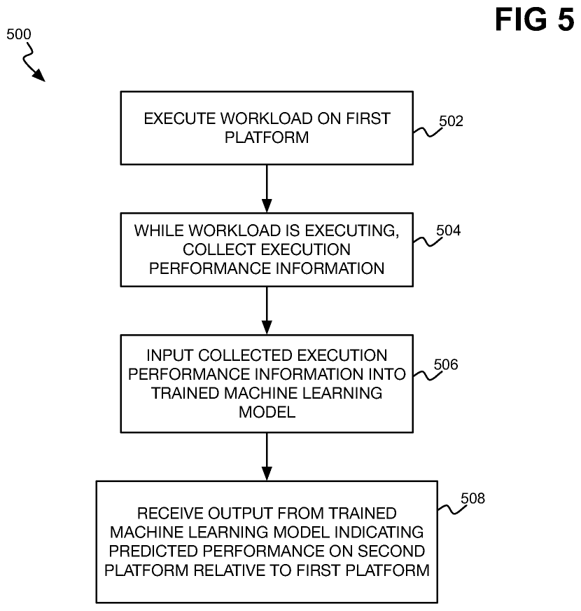

FIG. 5 shows an example method 500 for using the machine learning model trained in FIG. 1 to predict performance of a workload on a second hardware platform relative to known performance of the workload on a first hardware platform. The machine learning model was trained from execution performance information collected during execution of training workloads on the first and second platforms, as has been described. The method 500 can be implemented as a non-transitory computer-readable data storage medium storing program code executable by a computing device.

The method 500 includes executing a workload on the first hardware platform on which the machine learning model was trained (502). The first hardware platform on which the workload is executed may be the particular computing device on which the training workloads were previously executed for training the machine learning model. The first hardware platform may instead by a computing device having the same specifications—i.e., constituent hardware components having the same specifications—as the computing device on which the training workloads were previously executed.

The workload that is executed on the first hardware platform may be a workload that is normally executed on this first platform, and for which whether there would be a performance benefit in instead executing the workload on the second hardware platform is to be assessed without actually executing the workload on the second platform. Such an assessment may be performed to determine whether to procure the second hardware platform, for instance, or to determine whether subsequent executions of the workload should be scheduled on the first or second platform for better performance. The workload can include one or more processing tasks that specified application programs run on provided data in a provided order.

The method 500 includes, while the workload is executing on the first hardware platform, collecting execution performance information of the workload on the first hardware platform (504). For example, the computing device performing the method 500 may transmit to the first hardware platform an agent computer program that collects the execution performance information from the time that workload execution has started to the time that workload execution has finished. A user may initiate workload execution on the first hardware platform and then signal to the agent program that workload execution has started, and once workload execution has finished may similarly signal to the agent program that workload execution has finished. In another implementation, the agent program may initiate workload execution and correspondingly begin collecting execution performance information, and stop collecting the execution performance information when workload execution has finished. The agent computer program may then transmit the execution performance information that it has collected back to the computing device performing the method 500.

The execution performance information that is collected on the first hardware platform includes the values of the same hardware and software statistics, metrics, counters, and traces that were collected for the training workloads during training of the machine learning model. Thus, the execution performance information that is collected on the first hardware platform while the workload is executed includes execution traces for the same metrics that were collected for the training workloads. As with the training workloads, the execution performance information collected for the workload in part 504 does not include the workload itself, such as the specification application programs (including any code or any identifying information thereof) that are run as processing tasks as part of the workload, and such as the order in which the tasks are performed during workload execution. Similarly, the execution performance information does not include the (user) data on which the processing tasks are operative, or any identifying information of such (user) data.

Therefore, no part of the workload, including the data that has been processed during execution of the workload, is transmitted from the first hardware platform to the computing device performing the method 500. As such, confidentiality is maintained, and users who are particularly interested in assessing whether their workloads would benefit in performance if executed on the second hardware platform instead of on the first hardware platform can perform such analysis without sharing any information regarding the workloads. The information on which basis the machine learning model predicts performance on the hardware platform relative to known performance on the first platform in the method 500 includes just the execution traces that were collected during workload execution on the first platform.

It is noted that while in the implementation of FIG. 5 the first hardware platform on which the workload is executed is the first hardware platform on which the machine learning model has been trained, the workload itself does not have to be—and will in all likelihood not be—any of the training workloads that were executed during machine learning model. The machine learning model is trained from collected execution performance information of training workloads on the first and second hardware platforms so that execution performance information of any workload that is collected on the first platform can be used by the model to predict performance on the second hardware relative to known performance on the first platform. The machine learning model learns, from collected execution performance information of training workloads on the both the first and second hardware platforms, how to predict from execution performance information collected during execution of any workload part on the first platform, performance on the second platform relative to known performance on the first platform.

The method 500 includes inputting the collected execution performance information into the trained machine learning model (506). For instance, the agent computer program that collected the execution performance information may transmit this collected information to the computing device performing the method 500, which in turn inputs the information into the machine learning model. As another example, the agent program may save the collected execution performance information on the first hardware platform or another computing device, and a user may upload or otherwise transfer the collected information via a web site or web service to the computing device performing the method 500.

The method 500 includes receiving output from the trained machine learning model indicating predicted performance of the workload on the second hardware platform relative to known performance of the workload on the first hardware platform (508). The predicted performance can then be used in a variety of different ways. The predicted performance of the workload on the second hardware platform can be used to assess whether to procure the second hardware platform for subsequent execution of the workload. For example, a user may be contemplating purchasing a new computing device (viz., the second hardware platform), but be unsure as to whether there would be a meaningful performance benefit in the execution of the workload in question on the computing device as opposed to the existing computing device (viz., the first hardware platform) that is being used to execute the workload.

Similarly, the user may be contemplating upgrading one or more hardware components of the current computing device, but be unsure as to whether a contemplated upgrade will result in a meaningful performance increase in executing the workload. In this scenario, the current computing device is the first hardware platform, and the current computing device with the contemplated upgraded hardware components is the second hardware platform. For a workload that is presently being executed on a current or existing computing device, a user can therefore assess whether instead executing the workload on a different computing device (including the existing computing device but with upgraded components) would result in increased performance, without actually having to execute the workload on the different computing device in question.

The predicted performance can be used for scheduling execution of the workload within a cluster of heterogeneous hardware platforms including the first hardware platform and the second hardware platform. A scheduler is a type of computer program that receives workloads for execution, and schedules when and on which hardware platform each workload should be executed. Among the factors that the scheduler considers when scheduling a workload for execution is the expected execution performance of the workload on a selected hardware platform. For example, a given workload may during pre-deployment or preproduction have had to have been executed at least once on each different hardware platform of the cluster to predetermine performance of the workload on that platform. This information would then have been used when the workload was subsequently presented during production or deployment for execution, to select the platform on which to schedule execution of the workload.

By comparison, in the method 500, a workload that is to be scheduled for execution is executed on just the first hardware platform during pre-deployment or preproduction. When the workload is subsequently presented during production or deployment for execution, the scheduler can predict performance of the workload on the second platform relative to the known performance of the workload on the first platform, to schedule the platform on which to schedule execution of the workload. The usage of the machine learning model to predict workload performance on the second platform relative to the known workload performance on the first platform can instead also be performed during pre-deployment or preproduction, instead of at time of scheduling.

For example, when receiving a workload that that has been previously executed on the first hardware platform, the scheduler may determine the predicted performance of the workload on the first hardware platform relative to the first hardware platform. The scheduler may then schedule the workload for execution on the platform at which better performance is expected. For instance, if the predicted performance of the workload on the second platform is such that the second platform is likely to take less time to complete execution of the workload (i.e., the predicted performance relative to the first platform is better), then the scheduler may schedule the workload for execution on the second platform. By comparison, if the predicted workload performance on the second platform is such that the second platform is likely to take more time to complete execution of the workload (i.e., the predicted performance relative to the first platform is worse), then the scheduler may schedule the workload for execution on the first platform.

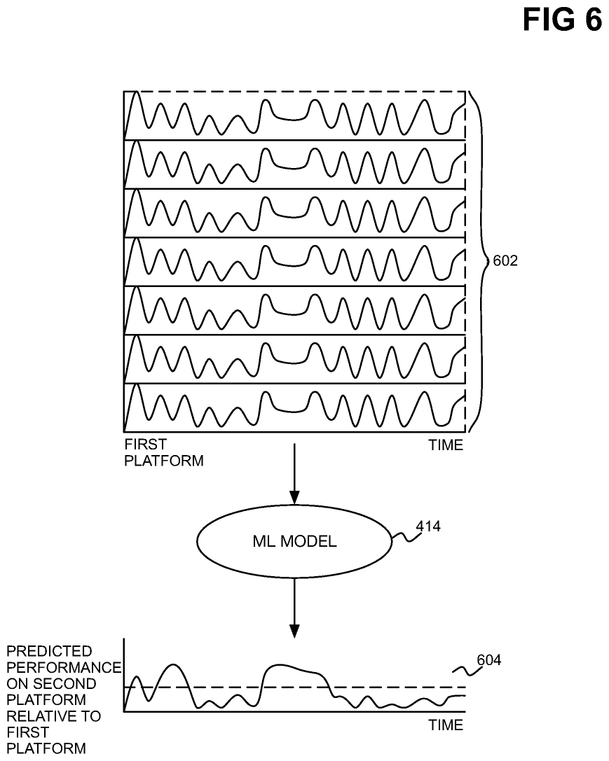

FIG. 6 illustratively shows example machine learning model usage in the method 500 of FIG. 5. A workload is executed on the first hardware platform and execution performance information 602 of the same type collected during machine learning model training is collected and input into the machine learning model 414. The machine learning model 414 outputs the predicted performance of the workload on the second hardware platform relative to the known performance of the workload on the first hardware platform, as indicated in FIG. 6 by referenced number 604.

The known performance of the workload on the first hardware platform can be considered as the length of time it takes to execute the workload on the first hardware platform. The predicted performance of the workload on the second hardware platform can thus be considered as the length of time it is expected to take to execute the workload on the second hardware platform. The machine learning model 414 outputs this prediction for each part of the workload—i.e., at each time interval or point in time in which the workload was executed on the first platform.

For a combination of values of metrics of the execution traces collected during execution of any given workload part on the first platform, the machine learning model 414 can specifically output how much faster or slower it is expected to take the second platform to execute the same workload part. At each time t at which the execution performance information was collected on the first hardware platform, the machine learning model 414 thus outputs the expected performance on the second hardware platform relative to the first platform. For instance, at a given time t, the machine learning model 414 may provide a ratio R. The ratio R may be the ratio of the expected execution time of the same part of the workload on the second platform as was executed on the first platform at that time t, to the length of time of the time interval between consecutive times t at which execution performance information was collected on the first platform.

As an example, the first hardware platform may execute a given part of the workload at a specific time t in X seconds, corresponding to the execution performance information being collected every X seconds, where the next part of the workload is executed at time t+X, and so on. That the machine learning model 414 outputs the ratio R for the execution performance information collected on the first platform at time t means that the second hardware platform is expected to execute this same part of the workload in R×X seconds, instead of in X seconds as on the first hardware platform. In other words, at each time t, the first platform executes a part of the workload in a length of time equal to the duration X between consecutive times t at which execution performance information is collected. Given a combination of the values of the first platform's execution traces at time t, the machine learning model 414 outputs a ratio R. This ratio R is the ratio of the predicted length of time for the second platform to execute the part of the workload that was executed on the first platform at time t, to the length of time (i.e., the duration X) it took the first platform to execute the workload part in question.

If the ratio R is less than one (i.e., less than 100%), therefore, then the second platform is predicted to execute this workload part more quickly than the first platform did. By comparison, if the ratio R is greater than one (i.e., greater than 100%), then the second platform is predicted to execute the workload part more slowly than the first platform did. The total predicted length of time for the second platform to execute the workload is thus a summation of the average of the ratio R at each time t multiplied by the total length of time over which execution performance information for the workload was collected on the first platform.

The implementation that has been described trains a machine learning model on a first hardware platform and a second hardware platform, and that is then used to predict workload execution performance on the second platform relative to known workload execution performance on the first platform. The machine learning model is specific to the first and second hardware platforms and cannot be used to predict performance on any target platform other than the second platform in relation to any source platform other than the first platform. The machine learning model is also directional in that the model predicts performance on the second platform relative to known performance on the first platform and not vice-versa. A different machine learning model would have to be generated to predict performance on the first platform relative to known performance on the second platform.

The machine learning model is specific and directional in these respects, because the model has no way to take into account how differences in hardware platform specifications affect predicted performance relative to known performance. The model is not trained on the hardware specifications of the first and second hardware platforms (i.e., no identifying or specifying information of any constituent hardware component of either platform is used or otherwise input for model training). When the machine learning model is used, the hardware platform specifications of the source (e.g., first) and target (e.g., second) platforms are not provided to the machine learning model (i.e., no identifying or specifying information of any constituent hardware component of either platform is used or otherwise input for model use). Even if the specifications were provided, the machine learning model cannot use this information, because the model was not previously trained to consider hardware platform specifications. The model assumes that the execution performance information that is being input was collected on the first platform on which the model was trained, and provides output as to predicted performance on the second platform on which the model was trained, relative to known performance on the first platform.

However, in another implementation, the training and usage of the machine learning model can be extended so that the model predicts performance on any target hardware platform relative to any source hardware platform. The target hardware platform may be the second hardware platform, or any other hardware platform. Similarly, the source hardware platform may be the first hardware platform, or any other hardware platform. To extend the machine learning model in this manner, the machine learning model is also trained on the hardware specifications of both the first and second hardware platforms. That is, machine learning model training also considers the specifications of the first and second platforms. The machine learning model can also be trained on other hardware platforms, besides the first and second platforms.

The resulting machine learning model can then be used to predict performance of any target hardware platform (i.e., not just the second platform) relative to known performance of any source hardware platform (i.e., not just the first platform) on which a workload has been executed. As before, the execution performance information collected during execution of the workload on the source platform is input into the model. However, the hardware specifications of this source hardware platform, and the hardware specifications of the target hardware platform for which predicted relative performance is desired, are also input into the model. Because the machine learning model was previously trained on hardware platform specifications, the model can thus predict performance of the target platform relative to known performance of the source platform, even if the machine learning model was not specifically trained on either or both of the source and target platforms.

The hardware platform specifications can include, for each hardware platform on which the machine learning model is trained, identifying or specifying information of each of a number of constituent hardware components of the platform. The more constituent hardware components of each hardware platform for which such identifying or specifying information is provided during model training, the more accurate the resulting machine learning model may be in predicting performance of any target platform relative to known performance of any source platform. Similarly, the more detailed the identifying or specifying information that is provided for each such constituent hardware component during training, the more accurate the resulting model may be. The same type of identifying or specifying information is provided for each of the same types of hardware components of each platform on which the model is trained.

When the machine learning model is then used to predict performance on a target hardware platform relative to known performance on a source hardware platform, the hardware specifications of each of the target and source platforms are specified or identified in the same way. That is, for each of the target and source platforms, the same type of identifying or specifying information is input into the machine learning model for each of the same types of hardware components as was considered during model training. With this information, along with the execution performance information collected on the source hardware platform during workload execution, the machine learning model can output predicted performance on the target platform relative to known performance on the source platform.

The hardware components for which identifying or specifying information is provided during model training and usage can include processors, GPUs, network hardware, memory, and other hardware components. The identifying or specifying information may include the manufacturer, model, make, or type of each component, as well as numerical specifications such as speed, frequency, amount, capacity, and so on. For example, a processor may be identified by manufacturer, type, number of processing cores, burst operating frequency, regular operating frequency, and so on. As another example, memory may be identified by manufacturer, type, number of modules, operating frequency, amount (i.e., capacity), and so on.

The predicted execution performance has been described in relation to FIGS. 5 and 6 as to execution time on the target hardware platform relative to the source hardware platform. However, the predicted execution performance may be other types of performance measures, such as power consumption, processor temperature, and so on. A machine learning model can be trained, in other words, on a desired type of performance measure, and then subsequently used to predict performance of this type on the target hardware platform relative to the source hardware platform.

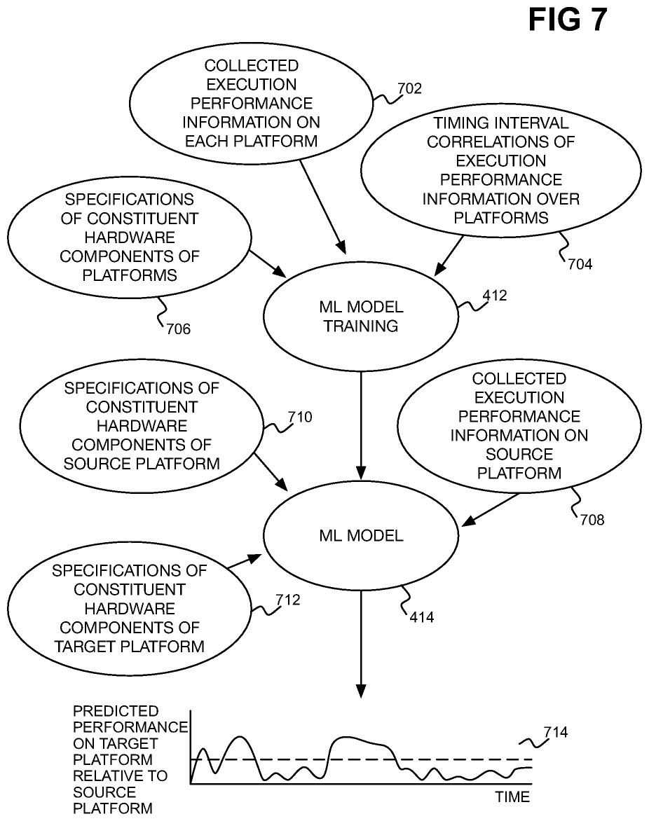

FIG. 7 illustratively depicts an example of how model training in FIGS. 1 and 4 and model usage in FIGS. 5 and 6 can be extended so that the trained machine learning model can be used to predict performance on any target hardware platform relative to known performance on any source hardware platform. FIG. 7 thus depicts the additional input on which basis model training occurs so that the trained machine learning model can predict performance on any target platform relative to known performance on any source platform, even if the model was not trained on the source and/or target platforms in question. FIG. 7 likewise depicts the additional input on which basis machine learning model usage occurs when predicting performance on any such target platform relative to known performance on any such source platform.

Machine learning model training 412 occurs on the basis of executed performance information 702 collected on each of a number of hardware platforms, which can be referred to as training platforms. The collected executed performance information 702 can include the executed performance information 402 and 404 of FIG. 4 that have been described, in which the information 402 and 404 is collected during execution of training workloads on the first and second hardware platforms, respectively. The collected executed performance information 702 can also include execution performance information 702 that is collected during execution of these same training workloads on one or more other hardware platforms. As noted above, the more hardware platforms for which executed performance information 702 is collected, the better the machine learning model 414 will likely be in predicting workload performance on a target hardware platform relative to known workload performance on a source hardware platform.

Machine learning model training 412 also occurs on the basis of timing interval correlations 704 among the collected execution performance information 702 over the hardware platforms. The timing interval correlations 704 can include the timing interval correlations 310 between the execution performance information 402 on the first platform and the execution performance information 404 on the second platform of FIG. 4. The timing interval correlations 704 further include timing interval correlations with respect to the execution performance information that has been collected on each additional hardware platform, if any. For example, if there is also a third hardware platform on which basis model training 412 occurs, the correlations 704 will include correlations of the timing intervals of the execution performance information of the first, second, and third platforms in which the same workload parts were executed.

Machine learning model training 412 further occurs on the basis of the specifications 706 of the constituent hardware components of the hardware platforms on which training workloads have been executed. The constituent hardware component specifications 706 of each hardware platform include specifying or identifying information of each of a number of constituent hardware components, as has been described. By performing machine learning model training 412 on the basis of such constituent hardware component specifications 706, the resulting machine learning model 414 is not directional and is not specific to any pair of the hardware platforms on which the model 414 was trained.

To use the machine learning model 414 that has been trained, a workload is executed on a source hardware platform and execution performance information 708 of the same type collected during machine learning model training 412 is collected and input into the model 414. The specifications 710 of the constituent hardware components of this source platform are input in the machine learning model 414, too, as are the specifications 712 of the constituent hardware components of a target hardware platform for which performance relative to the known performance on the source platform is desired to be predicted. The specifications 710 and 712 identify or specify the constituent hardware components of the source and target platforms, respectively, in the same manner in which the specifications 706 identify or specify the constituent hardware components of the platforms on which the model 412 was trained. Because the model 414 was trained on the basis of such constituent hardware component specifications, the model 414 can predict performance of any target platform relative to known performance on any source platform, so long as the source and target platforms have their constituent hardware components identified or specified in a similar manner.

The machine learning model 414 outputs the predicted performance of the workload on the specified target hardware platform relative to the known performance of the workload on the specified source hardware platform, as indicated in FIG. 7 by reference number 714. The known performance of the workload on the source platform encompasses the execution performance information 706 that was collected on the source platform during execution of the workload and then input into the machine learning model 414. The predicted performance of the workload on the target platform relative to this known performance can include, for each part of the workload executed on the source platform (i.e., at each time interval or point in time in which the workload was executed on the source platform), how much faster or slower the target platform will likely take to execute this same workload part, as has been described.

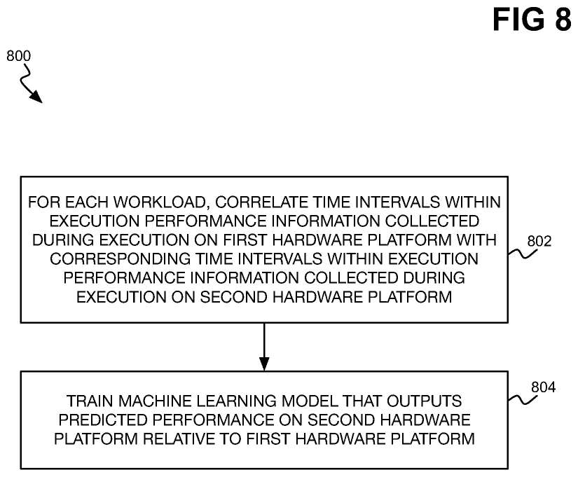

FIG. 8 shows an example method 800 for training a machine learning model. The method 800 includes, for each of a number of workloads, correlating time intervals within execution performance information collected during execution of the workload on a first hardware platform with corresponding time intervals within execution performance information collected during execution of the workload on a second hardware platform and during which same workload parts were executed (802). The method 800 includes training a machine learning model that outputs predicted performance on the second hardware platform relative to known performance on the first hardware platform (804). The machine learning model is trained from the time intervals within the execution performance information for each workload on the first platform and the corresponding time intervals within the execution performance information for each workload on the second platform, as have been correlated with one another.

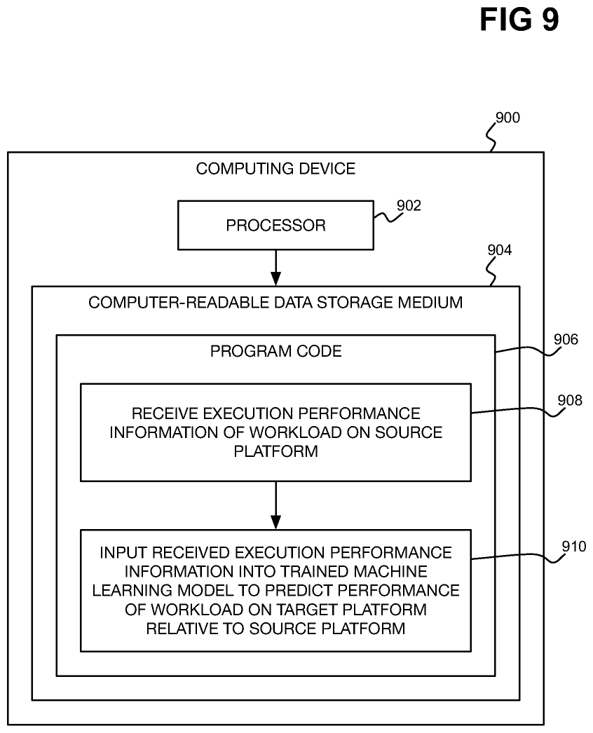

FIG. 9 shows an example computing device 900. The computing device 900 can include a processor 902 and a non-transitory computer-readable data storage medium 904 storing program code 906. The computing device 900 can include other hardware besides the processor 902 and the computer-readable data storage medium 904. The program code 906 is executable by the processor 902 to receive execution performance information of a workload on a source hardware platform collected during execution of the workload on the source hardware platform (908). The program code 906 is executable by the processor 902 to input the collected execution performance information into a machine learning model trained on correlated time intervals within execution performance information of hardware platforms collected during execution of the training workloads on the platforms (910). The machine learning model predicts performance of the workload on the target platform relative to known performance of the workload on the source platform.

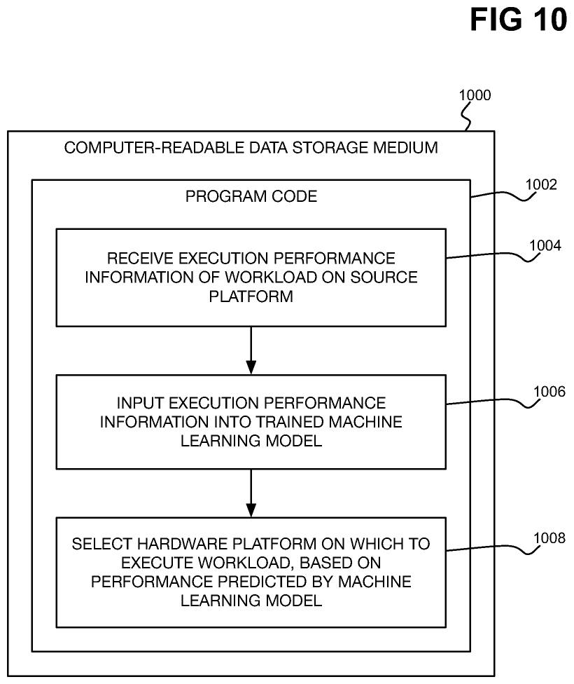

FIG. 10 shows an example non-transitory computer-readable data storage medium 1000 storing program code 1002. The program code 1002 is executable by a processor to perform processing. The processing includes receiving execution performance information of a workload on a source hardware platform previously collected while the workload was executed on the source hardware platform (1004). The processing includes inputting the execution performance information into a machine learning model to predict performance of the workload on a target hardware platform relative to known performance of the workload on the source hardware platform (1006). The model was trained on correlated time intervals within execution performance information of training hardware platforms collected during execution of training workloads on the hardware platforms.

The processing includes selecting an execution hardware platform on which to execute the workload, from a number of execution hardware platforms including the target hardware platform, based on the predicted performance of the workload (1008). The execution hardware platforms may include the source hardware platform. The execution hardware platforms may include the training hardware platforms, and the source and/or target hardware platforms may each be a training hardware platform. In another implementation, the execution hardware platforms may not include the training hardware platforms.

It is noted that the usage of the phrase hardware platforms herein encompasses virtual appliances or environments, as may be instantiated within a cloud computing environment or a data center. Examples of such virtual appliances and environments include virtual machines, operating system instances virtualized in accordance with container technology like DOCKER container technology or LINUX container (LXC) technology, and so on. As such, a platform can include such a virtual appliance or environment in the techniques that have been described herein.

A machine learning model has been described that can predict workload performance on a target hardware platform relative to known workload performance on a source hardware platform. In one implementation, the model may be directional and specific to the source and target platforms, such that the model is trained and used without consideration of any specifying or identifying information of any constituent hardware component of either or both the source and target platforms. In another implementation, the model may be more general and not directional or specific to the source and target platforms, such that the model is trained and used in consideration of specifying or identifying information of constituent hardware components of training hardware platforms and the source and target platforms.

We claim:

1. A method comprising:
for each of a plurality of workloads, correlating time intervals within execution performance information that was collected during execution of the workload on a first hardware platform with corresponding time intervals within execution performance information that was collected during execution of the workload on a second hardware platform and during which same parts of the workload were executed; and
training a machine learning model that outputs predicted performance on the second hardware platform relative to known performance on the first hardware platform, the machine learning model trained from the time intervals within the execution performance information for each workload on the first hardware platform and the corresponding time intervals within the execution performance information for each workload on the second hardware platform, as have been correlated with one another.

2. The method of claim 1, further comprising:
using the machine learning model to predict performance of a workload on the second hardware platform relative to the known performance on the first hardware platform, by inputting into the machine learning model execution performance information that was collected during execution of the workload on the first hardware platform,
wherein the machine learning model outputs, for each a plurality of time intervals over which the execution performance was collected during execution of the workload on the first hardware platform, a ratio of a predicted execution time of a same part of the workload on the second hardware platform as was executed on the first hardware platform during the time interval to a length of time of the time interval.

3. The method of claim 1, further comprising:
executing each workload on each of a plurality of hardware platforms including the first hardware platform and the second hardware platform; and
while each workload is executing on each hardware platform, collecting the execution performance information over time.

4. The method of claim 1, further comprising:
aggregating the execution performance information that was collected during execution of each workload on each of the first hardware platform and the second hardware platform prior to correlating the time intervals within the execution performance information for the workload on the first hardware platform with the corresponding time intervals within the execution performance information for the workload on the second hardware platform.

5. The method of claim 1, wherein, for each workload and each of a plurality of hardware platforms including the first hardware platform and the second hardware platform, the execution performance information comprise values of hardware and software statistics, metrics, counters and, traces over time as the workload executes on the hardware platform.

6. The method of claim 1, wherein the machine learning model is trained and subsequently used to predict performance on the second hardware platform relative to the known performance on the first hardware platform without using any identifying information of any application code run during execution of any workload or any identifying information of any user data of any workload.

7. A computing device comprising:
a processor;
a non-transitory computer-readable data storage medium storing program code executable by the processor to:
receive execution performance information of a workload on a source hardware platform collected during execution of the workload on the source hardware platform; and
input the execution performance information into a machine learning model trained on correlated time intervals within execution performance information of a plurality of hardware platforms collected during execution of a plurality of training workloads on the hardware platforms, to predict performance of the workload on the target hardware platform relative to known performance of the workload on the source hardware platform.

8. The computing device of claim 7, wherein the predicted performance of the workload is used to assess whether to procure the target hardware platform for executing the workload.

9. The computing device of claim 7, wherein the hardware platforms on which the model learning model is trained includes the source hardware platform and the target hardware platform, is specific to the source hardware platform and the target hardware platform, and further is specific to predicting performance on the target hardware platform relative to the known performance on the source hardware platform.

10. The computing device of claim 7, wherein the machine learning model is trained and used to predict performance on the target hardware platform relative to the known performance on the source hardware platform without using or inputting any identifying or specifying information of any constituent hardware component of either hardware platform.

11. The computing device of claim 7, wherein the machine learning model outputs, for each of a plurality of time intervals over which the execution performance was collected during execution of the workload on the source hardware platform, a ratio of a predicted execution time of a same part of the workload on the target hardware platform as was executed on the source hardware platform during the time interval to a length of time of the time interval.

12. A non-transitory computer-readable data storage medium storing program code executable by a processor to perform processing comprising:
receiving execution performance information of a workload on a source hardware platform previously collected while the workload was executed on the source hardware platform;
inputting the execution performance information into a machine learning model trained on correlated time intervals within execution performance information on a plurality of training hardware platforms collected during execution of a plurality of training workloads on the hardware platforms, to predict performance of the workload on a target hardware platform relative to known performance of the workload on the source hardware platform; and
selecting an execution hardware platform on which to execute the workload, from a plurality of execution hardware platforms including the target hardware platform, based on the predicted performance of the workload.

13. The non-transitory computer-readable data storage medium of claim 12, wherein the machine learning model has further been trained based on identifying or specifying information of each of a plurality of constituent hardware components of each training hardware platform.

14. The non-transitory computer-readable data storage medium of claim 13, wherein the machine learning model is not specific to the source hardware platform and the target hardware platform,
and wherein to predict the performance of the workload on the target hardware platform relative to the known performance of the workload on the source hardware platform, identifying or specifying information of each of a plurality of constituent hardware components of each of the source hardware platform and the target hardware platform is input into the machine learning model.

15. The non-transitory computer-readable data storage medium of claim 12, wherein the machine learning model outputs, for each of a plurality of time intervals over which the execution performance was collected during execution of the workload on the source hardware platform, a ratio of a predicted execution time of a same part of the workload on the target hardware platform as was executed on the source hardware platform during the time interval to a length of time of the time interval.
